(19) United States
(12) Patent Application Publication
(10) Pub. No.: US 2008/0133673 A1
(43) Pub. Date: Jun. 5, 2008

(54) METHOD AND APPARATUS TO CONTROL CONTENTS IN A DOCUMENT

(76) Inventors: Sanaa F. Abdelhadi, Richardson, TX (US); Jennifer Lee Carlucci, Mission Viejo, CA (US); Danling Shi, Austin, TX (US); Christopher J. Tan, Austin, TX (US)

Correspondence Address: IBM CORP (YA);C/O YEE & ASSOCIATES PC, P.O. BOX 802333, DALLAS, TX, 75380, US

(21) Appl. No.: 11/566,271

(22) Filed: Dec. 4, 2006

(51) Int. Cl. G06F 15/16

(52) U.S. Cl. 709/206

(57) ABSTRACT

A computer implemented method, apparatus, and computer usable program code for controlling an e-mail document. Responsive to a user input by a recipient to perform a manipulation on the e-mail document, a determination is made as to whether a constraint against the manipulation is present for a section of the e-mail document, wherein the section is less than all of the e-mail document. Manipulation is prevented on the section of the e-mail document in response to the constraint against the manipulation being present.

### BACKGROUND OF THE INVENTION

1. Field of the Invention

The present invention relates generally to an improved data processing system in particular to a method and apparatus for processing data. Still more particularly, the present invention relates to a computer implemented method, apparatus, and computer usable program code for managing the content in an e-mail document.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travel over the Internet through a variety of languages also referred to as protocols. The set of protocols used on the Internet is called the Transmission Control Protocol/Internet Protocol (TCP/IP).

The Internet has revolutionized communications and commerce as well as being a source of information and entertainment. For many users, e-mail is a widely used format to communicate over the Internet. It is commonplace for users to send e-mail messages to others users through the Internet.

The use of e-mail messages is commonplace for personal and business use. E-mail messages are used by individuals to keep in touch with and communicate with other users. Additionally, e-mail messages provide a medium to collaborate and exchange documents.

In the collaboration and exchange of documents through e-mail, content integrity of the e-mail document may be a concern. When a document is forwarded to a third party, the original content of the e-mail document may have been modified without the third party knowing about any modification. Receipt of modified documents by third parties may result in a miscommunication of messages or intent.

Therefore, it would be advantageous to have an improved computer implemented method, apparatus, and computer useable code for managing the content of e-mail documents.

### SUMMARY OF THE INVENTION

The present invention provides a computer implemented method, apparatus, and computer usable program code for controlling an e-mail document. Responsive to a user input by a recipient to perform a manipulation on the e-mail document, a determination is made as to whether a constraint against the manipulation is present for a section of the e-mail document, wherein the section is less than all of the e-mail document. Manipulation is prevented on the section of the e-mail document in response to the constraint against the manipulation being present.

In another embodiment, a user interface is presented to set properties for the e-mail document. The e-mail document is displayed in the user interface to form a displayed e-mail document. A set of constraints is displayed that may be set in a selected section of the displayed e-mail document, wherein the selected section is less than all of the displayed e-mail document. The property for the selected section is set to form a controlled e-mail document in response to a constraint being selected from the set of properties for the selected section.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating an e-mail messaging system in accordance with an illustrative embodiment;

FIG. 4 is a diagram illustrating components used in controlling content in an e-mail document in accordance with an illustrative embodiment;

FIG. 5 is a diagram illustrating a user interface for setting properties for a document in accordance with an illustrative embodiment;

FIG. 6 is a diagram of a user interface presented when a document is opened by a user in accordance with an illustrative embodiment;

FIG. 7 is a diagram of a user interface presented when forwarding a document in accordance with an illustrative embodiment;

FIG. 8 is a flowchart of a process for adding properties to an e-mail document in accordance with an illustrative embodiment;

FIG. 9 is a flowchart of a process for opening a document in accordance with an illustrative embodiment;

FIG. 10 is a flowchart of a process for controlling editing of a document in accordance with an illustrative embodiment; and

FIG. 11 is a flowchart of a process for controlling content of a document in response to a request to forward the document in accordance with an illustrative embodiment.

### DETAILED DESCRIPTION OF THE PREFERRED EMBODIMENT

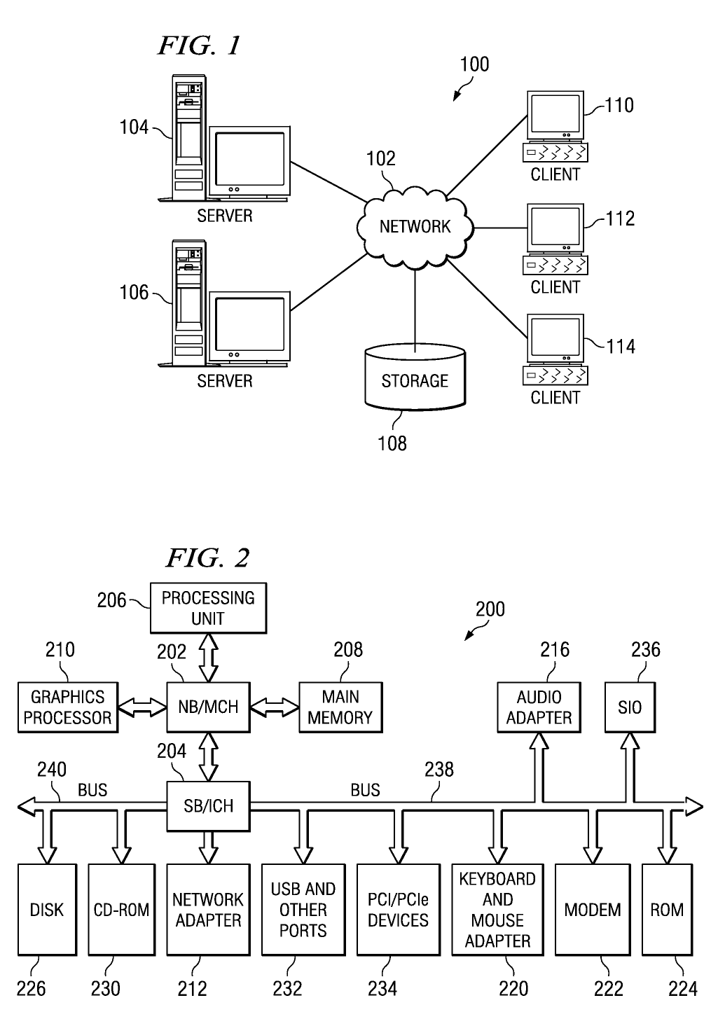

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104, which provides e-mail services in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

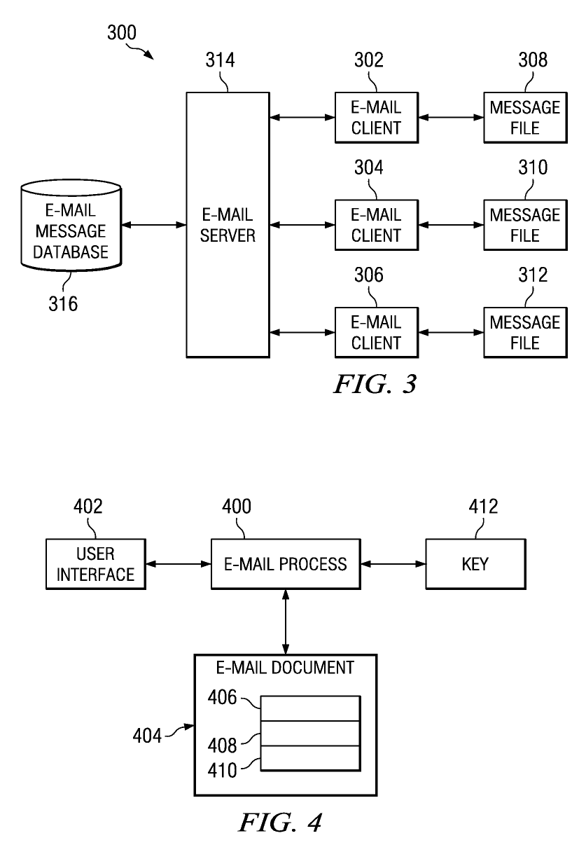

Turning now to FIG. 3, a diagram illustrating an e-mail messaging system is depicted in accordance with an illustrative embodiment. In this example, e-mail messaging system 300 includes e-mail client 302, e-mail client 304, and e-mail client 306, which are programs or applications located at different client data processing systems, such as client 110, client 112, and client 114 in FIG. 1. Message file 308, message file 310, and message file 312 are associated with these e-mail clients. These message files store e-mail messages received by the clients and may be organized into various mailboxes. Examples of various mailboxes include, for example, an in folder, a sent folder, a deleted folder, and an outbox folder.

These e-mail programs may employ different protocols depending upon the implementation. For example, simple mail transfer protocol (SMTP) is a standard e-mail protocol that is based on TCP/IP. This protocol defines a message format and the message transfer agent which stores and forwards the mail. Other protocols, such as post office protocol 3 (POP3), also may be employed.

These e-mail programs are used to send e-mails back and forth to different users through e-mail server 314. Messages sent to other e-mail clients are stored in e-mail message database 316. When an e-mail client connects to e-mail server 314, any messages for that particular client are then sent to the client. E-mail clients 302, 304, and 306 may be implemented using presently available e-mail clients.

The different embodiments recognize that management of content integrity is especially problematic with e-mail content. E-mail documents are usually forwarded to third parties in which the content integrity may be modified. In these illustrative examples, an e-mail document is an e-mail message or a document attached to the e-mail message. This e-mail document, may be, for example, a spreadsheet or a word processing document.

The different embodiments provide a computer implemented method, apparatus, and computer useable program code for controlling an e-mail document. Responsive to a user input by recipient to perform a manipulation on the e-mail document, a determination is made as to whether a constraint against the manipulation is present for a portion of the e-mail document. This portion is less than all of the e-mail document in these depicted examples. If the constraint against the manipulation is present, the manipulation is prevented on that portion of the e-mail document.

In this manner, the different embodiments allow a document originator or creator to manage the integrity of the content of an e-mail document by creating protection properties on particular portions or sections of the e-mail documents. The type of protections may be made or selected by setting content properties for different sections of the document.

These properties include, for example, “do not forward”, “write protect”, and “request response”. “Do not forward” and “write protect” are constraints that may be applied to a section of the e-mail document. “Do not forward” allows a user to mark a section of the document such that that section cannot be forwarded by recipient. In other words, when a recipient of the e-mail document tries to forward the e-mail document or just the selected section, that selected selection is removed from the forwarded message. Additionally, the recipient of the forwarded message also may receive a notification that a portion of the document has been removed. Another property that may be set is a “write protect” property. This property is a constraint against altering a section of the e-mail document.

Another property that may be set is to “request response”. This property means that a response is required from the recipient of the e-mail document. These properties are presented for proposes of illustration. Other properties may be defined and used in addition or in place of the ones in these examples.

Turning now to FIG. 4, a diagram illustrating components used in controlling content in an e-mail document is depicted in accordance with an illustrative embodiment. In this example, e-mail process 400 is used to control or manage content in e-mail document 404. A user may interface with e-mail process 400 through user interface 402. User interface 402 and e-mail process 400 are examples of components that may be found in an e-mail client, such as e-mail client 302 in FIG. 3.

When creating a document, a user may select a section of e-mail document 404, such as section 406, section 408, and/or section 410 through user input to user interface 402. By selecting one or more sections within e-mail document 404, a user may be presented with a list of properties that can be set for each section on user interface 402.

For example, a user may select a constraint for section 406 that prevents forwarding of this section in e-mail document 404. By making the selection, e-mail process 400 associates an identifier or tag with section 406 that indicates that forwarding is not allowed for that section of e-mail document 404. Section 406 also may be marked with another constraint, such as “write protect”, which prevents editing of that section. In addition, the user may select “request response” for the section to request a comment or response from the recipient of e-mail document 404.

When a user selects a section, such as section 406 in e-mail document 404, e-mail process 400 marks that section of the document. The selection of 406 may be performed in a number of different ways. For example, user may highlight the portion of the document that forms section 406. Alternatively, the user may mark the beginning and ending portions of the document that forms section 406. Similar user input through user interface 402 may be performed for the other sections in e-mail document 404.

After e-mail document 404 is modified to form a modified e-mail document, key 412 is generated. Only a user with key 412 may change or modify properties for document 404. For example, if the user wishes to make further changes to section 406 in e-mail document 404, the user must enter key 412 to make these changes because a “write protect” property has been set for section 406.

A recipient of e-mail document 404 may view and manipulate e-mail document 404 through user interface 402. If a user desires to edit section 406, e-mail process 400 determines whether a property in the form of a constraint against editing is present in section 406 for e-mail document 404. If this type of property is present, the user is provided with a notification that section 406 is “write protected”. Of course, the user may edit section 406 if the user also has key 412. If the user wants to make edits to section 406 and does not have key 412, the user may request key 412 from the sender of the document.

If the recipient decided to manipulate e-mail document 404 by forwarding this document, e-mail process 400 searches e-mail document 404 to determine whether a property in the form of a constraint against forwarding is present for any of the sections within e-mail document 404. Additionally, key 412 may be forwarded to the recipient if the sender wants to allow the recipient to have all rights to e-mail document 404. With the key, the recipient may make modifications and add or remove constraints to e-mail document 404. Further, key 412 may have an expiration date, such that the receiver of e-mail document 404 and key 412 do not have an indefinite amount of time to alter e-mail document 404.

In this example, section 406 has a constraint against forwarding. As a result, e-mail process 400 removes section 406 from e-mail document 404 and then forwards the document without the section. An indication or notification may be included in e-mail document 404 to indicate that section 406 has been removed. If the user wishes to forward that section of the e-mail document, the user may request a key 412 from the sender of the document. With key 412, the user may change the property in e-mail document 406 to allow forwarding.

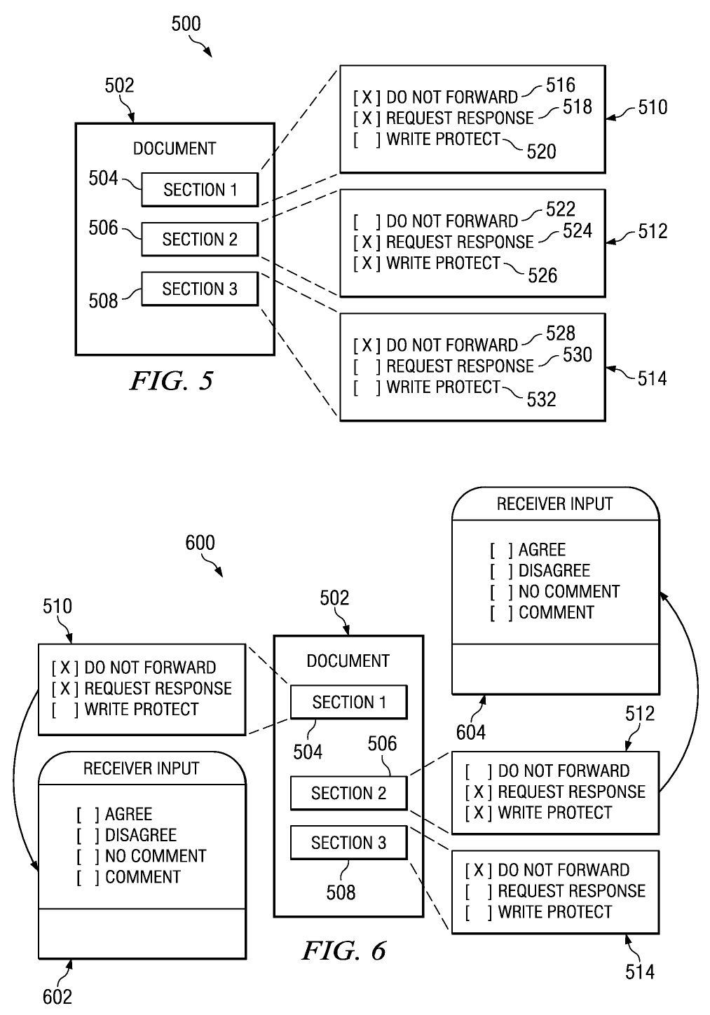

Turning now to FIG. 5, a diagram illustrating a user interface for setting properties for a document is depicted in accordance with an illustrative embodiment. Interface 500 is an example of the user interface, such as user interface 402 in FIG. 4. In this example, e-mail document 502 is an e-mail document, such as e-mail document 404 in FIG. 4. The user has marked sections 504, 506, and 508 to set of properties for those sections. As described above, these properties may be constraints, will prevent some manipulation of e-mail document 502. Alternatively, the property may be an action requiring an action from a recipient of e-mail document 502.

A user may right click on a mouse to view dialogs 510, 512, and 514. Each of these dialogs present a list of properties that may be set for sections 504, 506, and 508, respectively. Dialog 510 contains properties, 516, 518, and 520. In this example, properties 516 and 518 have been selected for section 504. Property 516 is “do not forward”, while property 518 is “request response”. Property 520 is unselected for section 504 and is a “write protect” property. Dialog 512 contains properties 522, 524, and 526. In this example, properties 524 and 526 have been selected for section 506. These properties are “request response” and “write protect”, respectively, property 522 is a “do not forward” property, which is unselected for section 506.

Next, dialog 514 includes properties 528, 530, and 532. In this example, only 528, “do not forward”, has been selected for section 508. Properties 530 and 532, “request response” and “write protect”, have not been selected for section 508.

When the user saves e-mail document 502 with these set properties, these properties are saved in association with e-mail document 502 along with a key generated for this document. In these examples, the key is an encrypted key and is required to make any further changes to the properties set for e-mail document 502.

Turning now to FIG. 6, a diagram of a user interface presented when a document is opened by a user is depicted in accordance with an illustrative embodiment. Interface 600 is an example of user interface 402 in FIG. 4. In this example, document 502 has been opened by the recipient in interface 600. The recipient may see the different properties for the document as shown in dialogs 510, 512, and 514.

Additionally, dialogs 602 and 604 are presented when the properties indicate that a request for response is set for those sections of the document. In this particular example, section 504, and section 506 both include a property in the form of an action requesting response from the user. Dialog 602 provides a mechanism to receive user input from the recipient regarding section 504. Dialog 604 provides a user an ability to enter input about section 506. No such dialog presented for section 508 because a request for a response has not been set for this section.

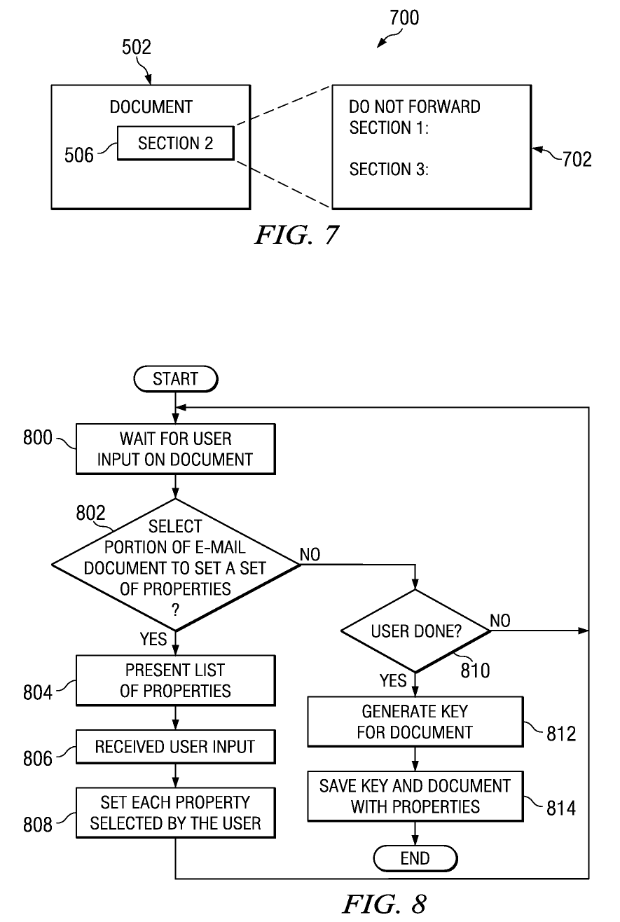

Turning now to FIG. 7, a diagram of a user interface presented when forwarding a document is depicted in accordance with an illustrative embodiment. In this example, user interface 700 is an example of user interface 402 in FIG. 4. In this particular instance, user has decided to forward e-mail document 502. Only section 506 is present because sections 504 and 508 from e-mail document 502 contained a “do not forward” property. Additionally, dialog 702 is presented providing a notification that these sections are sections of content in document 502 that will not be forwarded.

With reference now to FIG. 8, a flowchart of a process for adding properties to an e-mail document is depicted in accordance with an illustrative embodiment. The process illustrated in FIG. 8 may be implemented in a software component, such as e-mail process 400 in FIG. 4.

The process begins by waiting for user input on a document (step 800). When user input is received, a determination is made as to whether the user input selects a portion of the document to set a set of properties (step 802). If the user input selects a portion of the document to set a set of properties for that portion, a list of properties are presented (step 804). This list of properties may be presented in the form of a dialog similar to dialog 510 in FIG. 5.

Thereafter, user input in the dialog is received (step 806). The process then sets each property selected by the user for the portion of the e-mail document (step 808). The process then returns to step 800 to wait for another user input on the document. The property may be set my including an identifier or code that indicates the property is set for that section of the document. These indicators or codes are placed in a set of hidden codes not shown to the user with the document.

With reference again to step 802, if the user input does not select a portion of the document to set a set of properties, the process then determines whether the user is done or finished working with the document (step 810). If the user is not done, the process returns to step 800.

Otherwise, a key is generated for the document (step 812). In these examples, the key is an encryption key that is required to change properties for the document. In this manner, any user with this key is able to change properties for the document. Thereafter, the key and the document with the properties are saved (step 814) with the process terminating thereafter.

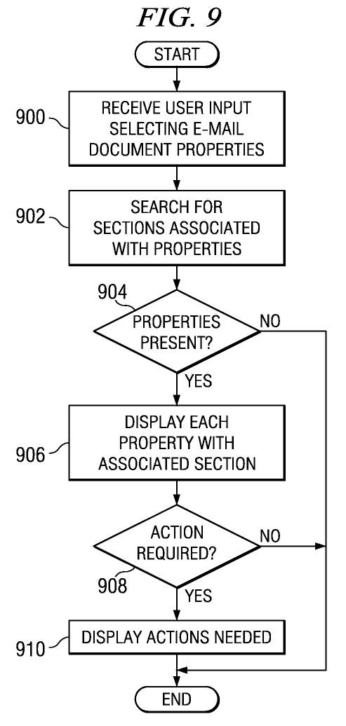

Turning next to FIG. 9, a flowchart of a process for opening a document is depicted in accordance with an illustrative embodiment. The process illustrated in FIG. 9 may be implemented in a software component, such as e-mail process 400 in FIG. 4.

The process begins by receiving a user input selecting e-mail document properties (step 900). The process then searches for sections associated with properties (step 902). A determination is made as to whether any properties are present (step 904). If properties are present in one or more sections of the e-mail document, each property is displayed in association with the section that the property applies (step 906). A display of properties in step 906 may be made in a fashion similar to that in interface 600 in FIG. 6.

Thereafter, a determination is made as to whether an action is required (step 908). The determination in step 908 is made by examining the properties to determine whether any of the properties take the form actions. If an action is present, the action needed is displayed (step 910) with the process terminating thereafter. The process terminates without taking any additional action if actions are not required in step 908.

With reference again to step 904, the process also terminates if properties are not present in the e-mail documents.

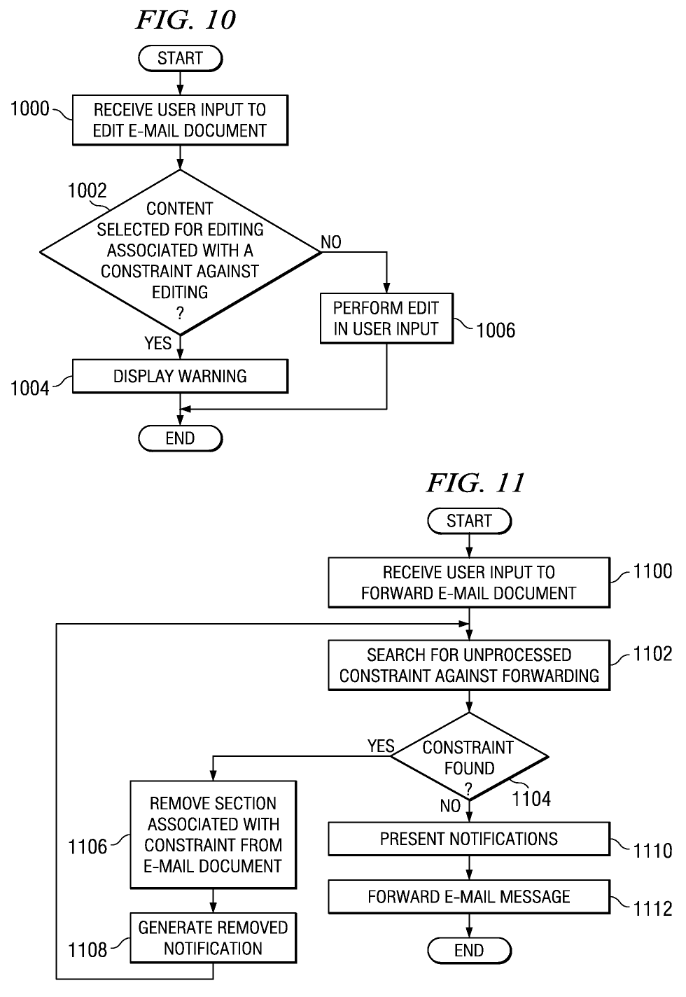

With reference to FIG. 10, a flowchart of a process for controlling editing of a document is depicted in accordance with an illustrative embodiment. The process illustrated in FIG. 10 may be implemented in a software component, such as e-mail process 400 in FIG. 4.

The process begins by receiving a user input to edit the e-mail document (step 1000). A determination is made as to whether the content selected for editing is associated with a constraint against editing (step 1002). In other words, a determination is made as to whether a “write protect” property is present for the section in which the content has been selected. If a constraint is present, a warning is displayed (step 1004) with the process terminating thereafter. In this case the editing action selected by the user input does not occur.

With reference again to step 1002, if the content is not associated with a constraint against editing, the edit identified by the user input is performed (step 1006) with the process terminating thereafter.

Turning to FIG. 11, a flowchart of a process for controlling content of a document in response to a request to forward the document is depicted in accordance with an illustrative embodiment. The process illustrated in FIG. 11 may be implemented in a software component, such as e-mail process 400 in FIG. 4.

The process begins by receiving user input to forward an e-mail document (step 1100). Thereafter, the process searches for an unprocessed constraint against forwarding (step 1102). A determination is made as to whether a constraint against forwarding has been found (step 1104). If the constraint has been found, a section associated with the constraint is removed from the e-mail document (step 1106). Thereafter, a removed notification is generated (step 1108). The process then returns to step 1102 to search for additional constraints.

With reference again to step 1104, if the constraint is not found, any notifications generated are presented (step 1110). Thereafter, the e-mail message is forwarded (step 1112) with the processes terminating thereafter.

The presentation of notifications in step 1110 may be made in various manners. For example, a dialog, such as, for example, dialog 602 in FIG. 6 may be displayed to the user. In step 1108, the notification of removed sections may also be placed within the e-mail document such that the recipient of the forwarded e-mail documents may see that sections have not been forwarded.

Thus, the different embodiments provide a computer implemented method, apparatus, and computer usable program code for controlling content in an e-mail document.

A determination is made as to whether a property, such as a constraint against manipulation is present for a section of an e-mail document in response to a user input to perform manipulation on that section of the e-mail document. This section is less than all of the e-mail documents in these examples. If the constraint against the manipulation is present, the manipulation is prevented on that section of the e-mail document.

In this manner, the different embodiments provide a user an ability to control the content of an e-mail document. This control allows for protection of the integrity of data in the document. Thus, a user may protect certain portions or sections of a document that are considered important. These types of protections are useful in all communications, and especially with respect to those for legal services.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. For example, although the depicted embodiments are applied to e-mail documents, the different processes may be applied to other types of documents. As one example, the different embodiments may be applied to legal documents. Further, these embodiments may be applied to an entire document in addition to a portion of the document. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for controlling an e-mail document, the computer implemented method comprising:
responsive to a user input by a recipient to perform a manipulation on the e-mail document, determining whether a constraint against the manipulation is present for a section of the e-mail document, wherein the section is less than all of the e-mail document; and
responsive to the constraint against the manipulation being present, preventing the manipulation on the section of the e-mail document.

2. The computer implemented method of claim 1, wherein the manipulation is to forward the e-mail document to a third party and wherein the preventing step comprises:
removing the section from the e-mail document to form a modified e-mail document; and
forwarding the modified e-mail document the recipient without the section of the document.

3. The computer implemented method of claim 1, wherein the manipulation is to edit the section of the document and wherein the preventing step comprises:
preventing editing of the section of the e-mail document.

4. The computer implemented method of claim 3, wherein the preventing step further comprises:
presenting an indication that editing of the section of the e-mail document is not allowed.

5. The computer implemented method of claim 1 further comprising:
responsive to a recipient of the e-mail document opening the e-mail document, determining a property requesting an action by the recipient is set in the e-mail document; and
responsive to a determination that a property requesting an action by the recipient is set in the e-mail document, presenting the requested action.

6. A computer implemented method for controlling an e-mail document, the computer implemented method comprising:
displaying the e-mail document in a user interface to form a displayed e-mail document;
displaying set of constraints that may be set a selected section of the displayed e-mail document in the user interface, wherein the selected section is less than all of the displayed e-mail document; and
responsive to a constraint being selected from the set of constraints for the selected section, setting the constraint for the selected section to form a controlled e-mail document.

7. The computer implemented method of claim 6 further comprising:
sending the controlled e-mail document to a recipient, wherein the recipient manipulates the e-mail document subject to the selected constraint on the selected section.

8. The computer implemented method of claim 6 further comprising:
displaying a set of actions that may be requests from a recipient of the e-mail document; and
responsive to a selection of an action from the set of actions, associating the action with the selected section of the e-mail document.

9. The computer implemented method of claim 6, wherein the constraint prevents at least one of forwarding of the selected section and editing of the selected section.

10. The computer implemented method of claim 7, wherein the action requests user input from the recipient on the selected section.

11. The computer implemented method of claim 6 further comprising:
generating a key for the controlled e-mail document, wherein the key may be sent to a recipient to allow a recipient of the controlled e-mail document to make changes to the set of constraints for the controlled e-mail document.

12. A computer program product comprising:
a computer usable medium having computer usable program code for controlling an e-mail document, the computer program medium comprising:
computer usable program code, responsive to a user input by a recipient to perform a manipulation on the e-mail document, for determining whether a constraint against the manipulation is present for a section of the e-mail document, wherein the section is less than all of the e-mail document; and
computer usable program code, responsive to the constraint against the manipulation being present, for preventing the manipulation on the section of the e-mail document.

13. The computer program product of claim 12, wherein the manipulation is to forward the e-mail document to a third party and wherein the computer usable program code, responsive to the constraint against the manipulation being present, for preventing the manipulation on the section of the e-mail document comprises:
computer usable program code for removing the section from the e-mail document to form a modified e-mail document; and
computer usable program code for forwarding the modified e-mail document the recipient without the section of the document.

14. The computer program product of claim 12, wherein the manipulation is to edit the section of the document and wherein the computer usable program code, responsive to the constraint against the manipulation being present, for preventing the manipulation on the section of the e-mail document comprises:
computer usable program code for preventing editing of the section of the e-mail document.

15. The computer program product of claim 14, wherein the computer usable program code, responsive to the constraint against the manipulation being present, for preventing the manipulation on the section of the e-mail document, further comprises:
computer usable program code for presenting an indication that editing of the section of the e-mail document is not allowed.

16. The computer program product of claim 12 further comprising:
computer usable program code, responsive to a recipient of the e-mail document opening the e-mail document, for determining a property requesting an action by the recipient is set in the e-mail document; and
computer usable program code, responsive to a determination that a property requesting an action by the recipient is set in the e-mail document, for presenting the requested action.

17. A data processing system comprising:
a bus;
a communications unit connected to the bus;
a storage device connected to the bus, wherein the storage device includes computer usable program code; and
a processor unit connected to the bus, wherein the processor unit executes the computer usable program code to determine whether a constraint against the manipulation is present for a section of the e-mail document, wherein the section is less than all of the e-mail document in response to a user input by a recipient to perform a manipulation on the e-mail document; and prevent the manipulation on the section of the e-mail document in response to the constraint against the manipulation being present.

18. The data processing system of claim 17, wherein the manipulation is to forward the e-mail document to a third party and wherein in executing the computer usable program code to prevent the manipulation on the section of the e-mail document in response to the constraint against the manipulation being present, the processor unit executes the computer usable program code to remove the section from the e-mail document to form a modified e-mail document; and forward the modified e-mail document the recipient without the section of the document.

19. The data processing system of claim 17, wherein the manipulation is to edit the section of the document and wherein in executing the computer usable program code to prevent the manipulation on the section of the e-mail document in response to the constraint against the manipulation being present, the processor unit executes the computer usable program code to prevent editing of the section of the e-mail document.

20. The data processing system of claim 19, wherein in executing the computer usable program code to prevent the manipulation on the section of the e-mail document in response to the constraint against the manipulation being present, the processor unit further executes the computer usable program code to present an indication that editing of the section of the e-mail document is not allowed.
